(19) United States
(12) Patent Application Publication
(10) Pub. No.: US 2015/0033111 A1
(43) Pub. Date: Jan. 29, 2015

(54) Document Creation System and Semantic macro Editor

(71) Applicant: KONINKLIJKE PHILIPS N.V., EINDHOVEN (NL)

(72) Inventors: Merlijn Sevenster, New York, NY (US); Yuechen Qian, Briarcliff Manor, NY (US)

(21) Appl. No.: 14/383,262

(22) PCT Filed: Mar. 6, 2013
(86) PCT No.: PCT/IB2013/051778

§ 371 Date: Sep. 5, 2014

Related U.S. Application Data
(60) Provisional application No. 61/611,735, filed on Mar. 16, 2012.

(51) Int. Cl. G06F 17/24; G06F 17/21

(52) U.S. Cl. CPC G06F 17/241; G06F 17/212
USPC 715/230

(57) ABSTRACT

A document creation system is disclosed. A text input unit (1) is arranged for receiving an input from a user for inclusion into a document (10) as text (11). A selection input unit (2) is arranged for receiving a user selection of a macro (15), wherein the macro comprises a text portion (16) and structured semantic information (17) relating to the text portion (16). A text inserter (3) is arranged for inserting the text portion (16) into the document (10), in response to the user selection. An annotation unit (4) is arranged for annotating the document (10) with an annotation (12) based on the structured semantic information (12). The text portion (16) of a macro (15) can comprise a blank to be filled in. A field input unit (6) is arranged for receiving from the user at least one value associated with said at least one blank.

### FIELD OF THE INVENTION

The invention relates to document creation. The invention further relates to macro editing.

### BACKGROUND OF THE INVENTION

Dictation software technology has revolutionized report authoring applications, such as the medical report authoring process. Previously, a clinician would dictate a report, which would then be transcribed by secretary personnel, and consequently approved by the clinician. With the advent of dictation software, clinicians verify the accuracy of a machine transcription themselves, dramatically reducing turn-around time.

Moreover, there is an ongoing demand for structured and normalized medical reports. It is anticipated that the structured data can be used to improve patient care, facilitate quality assurance, reduce costs in medicine, support clinical research, etc.

For more than two decades, researchers from the field of natural language processing and related areas have been working on developing automated means to structure the contents of natural language, and medical reports in particular. At present, existing natural language processing tools are limited in their capability to parse and add semantic structure to any type of medical report. Thus, extracting structured data from narrative data is difficult at present.

Creating structured data is also challenging. First of all, it involves clinicians to change their practice. Most radiologists are trained to use speech dictation systems nowadays. Asking them to adopt new graphic interfaces to fill in digital forms can significantly reduce their throughput, which is unlikely to happen in the short term. Second, structured reporting systems often incorporate comprehensive domain models of diseases, imaging modalities, procedures, etc. The breadth and depth of domain modeling systems sometimes may only accept “complete” observations from a clinician, which is perceived by the user a tedious task. Moreover, clinicians may feel “limited” by structured reporting systems, and may feel it is difficult or impossible to describe complicated clinical conditions that are sometimes not covered by domain modeling.

US20110202370 A1 discloses a medical software system with embedded transcription functionality. The system includes a clinical software module that is configured to be executed by a processor to create an electronic document and to capture clinical data for a patient in the electronic document during an encounter with the patient. The system also includes a transcription software application that is configured to be executed by the processor to select predefined clinical data that will appear within the electronic document in response to speech commands and to automatically transcribe dictated clinical data that will appear within the electronic document in response to dictation, wherein the predefined clinical data being previously linked to at least one of a diagnosis code and a procedure code and the dictated clinical data being automatically linked to at least one of a diagnosis code and a procedure code as it is transcribed.

WO 02/33691 A1 discloses a speech recognition system and interface used in the generation of medical reports from data in a hierarchically-organized database for the entry and searching of data in a database based on spoken utterances of a user. A workflow function facilitates a series of contexts, typically based on information in a knowledge base, that are used to establish procedural rules and word-mapping databases for each context for word-matching data entry based on spoken utterances of a user. The generation of medical reports from the entered medical data provides for searching the database generated using the speech recognition methods. The series of contexts and word-mapping database are developed using a hierarchically-organized database representation based on knowledge regarding the relationship of data items in the main database.

### SUMMARY OF THE INVENTION

It would be advantageous to have an improved document creation system. To better address this concern, a first aspect of the invention provides such a system, comprising

a text input unit arranged for receiving an input from a user for inclusion into the document as text;

a selection input unit arranged for receiving a user selection of a macro, wherein the macro comprises a macro text portion and structured semantic information relating to the text portion;

a macro inserter arranged for, in response to the user selection, inserting the text portion into the document and annotating the document with an annotation based on the structured semantic information.

The text input unit allows the user to provide free text input. Such input may be unconstrained regarding the structure or contents, giving a user complete freedom as to the information to be included in the report. Moreover, the features relating to a macro allow the user to insert a standardized text portion into the report with relative ease. Because the macro has structured semantic information relating to the text portion, annotating the document with structured semantic information is possible without any natural language processing of the text portion. This may improve the quality of the annotation and/or provide for reduced computational complexity involved in annotating the document with structured semantic information.

The document creation system may comprise a user controllable insertion point unit operatively coupled with the macro inserter and arranged for enabling a user to indicate a position within the document where the text portion is to be inserted. This position may be referred to as an insertion point. This allows the user to easily combine free text editing with quick insertion of text using a macro, wherein structured semantic information can easily be added to the document where a macro is inserted.

The text portion of a macro may comprise at least one blank to be filled in. Moreover, the system may comprise a field input unit arranged for receiving from the user at least one value associated with said at least one blank, and a fill-in unit for generating a completed text portion by filling in the blanks based on the at least one value. For example, a user interface may be provided that enables the user to fill in the blanks via typing or mouse-selection. The user interface may also provide a speech recognition system to enable the user to dictate the content to be filled into the blanks. Moreover, the text inserter may be arranged for inserting the completed text portion into the document. This makes the use of the macro more flexible, because a standardized text portion can be inserted into the document, with filled-in blanks. This way the document can also be annotated with structured semantic information when the text portion of a macro comprises one or more blanks.

The structured semantic information of a macro may comprise semantic information associated with the blank. This provides more detailed semantic annotation of the document.

The structured semantic information may comprise a type of information provided in the blank. This is useful semantic information to be included in the annotation of the document.

The text portion may comprise at least two blanks. Moreover, the structured semantic information may comprise a relationship between the two blanks. This is useful semantic information to be included in the annotation of the document.

The structured semantic information may comprise a relationship between the semantics of at least part of the predetermined text portion and said at least one blank. This is useful semantic information to be included in the annotation of the document.

The document creation system may comprise a parsing unit arranged for parsing the text of the document to find an occurrence of the text portion of the macro. This helps to identify an occurrence of a text that “could” have been inserted by means of the macro. The annotation unit may be arranged for annotating the occurrence based on the structured semantic information. Since the structured semantic information of the found text portion is known from the macro, the document can be annotated accordingly. When the text portion contains one or more blanks, the parsing unit may be arranged for detecting the text portion and the contents of the filled-in blanks as they appear in the document, and annotate the document with structured semantic information relating to the blanks accordingly.

In another aspect, the invention provides a macro editor for generating a macro. The macro editor may comprise:

a text unit arranged for receiving input indicative of a text portion;

a semantics unit arranged for receiving structured semantic information relating to the text portion;

a macro unit arranged for including the text portion and the structured semantic information into a macro. Such a macro may be used in a document creation system set forth herein.

The macro editor facilitates generation of a “semantic macro”, i.e. a macro that contains not only text to be inserted, but also structured semantic information capturing at least part of the semantic information entailed by the text of the macro.

The text unit of the macro editor may be arranged for enabling the user to include one or more blanks in the text portion. This allows more flexible text to be inserted using a macro, because the blank or blanks may be replaced by content as indicated by a user at a time the macro is inserted into a document.

The semantics unit may be arranged for enabling the user to indicate structured semantic information relating to the blank. This allows to provide annotation not only for a predetermined text portion, but also for a text portion including blanks.

The semantics unit may be arranged for enabling the user to indicate structured semantic information relating to a semantic relationship between at least two blanks of the at least one blank. This further enriches the structured semantic information of a semantic macro, thus enabling enriched annotation of a document using the macro.

In another aspect, the invention provides a workstation comprising the document creation system set forth and/or the macro editor set forth.

In another aspect, the invention provides a document creation method, comprising

receiving an input from a user for inclusion into the document as text;

receiving a user selection of a macro, wherein the macro comprises a macro text portion and structured semantic information relating to the text portion;

inserting the text portion into the document, in response to the user selection; and

annotating the document with an annotation based on the structured semantic information.

In another aspect, the invention provides a method of generating a macro, comprising

receiving input indicative of a text portion;

receiving structured semantic information relating to the text portion; and

including the text portion (16) and the structured semantic information into a macro for use in a document creation method or system set forth herein.

In another aspect, the invention provides a computer program product comprising instructions for causing a processor system to perform any one of the methods set forth herein or to implement the document creation system set forth or the macro editor set forth herein.

It will be appreciated by those skilled in the art that two or more of the above-mentioned embodiments, implementations, and/or aspects of the invention may be combined in any way deemed useful.

Modifications and variations of the image acquisition apparatus, the workstation, the system, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated hereinafter with reference to the drawings. The drawings are diagrammatic and not drawn to scale. Throughout the drawings, similar items are indicated by means of the same reference numerals.

FIG. 1 is a block diagram of a document creation system.

FIG. 2 is a block diagram of a macro editor.

FIG. 3 is a block diagram of a semantic macro.

FIG. 4 is a block diagram of a document creation method.

FIG. 5 is a visualization of a first semantic macro example.

FIG. 6 is a visualization of a second semantic macro example.

### DETAILED DESCRIPTION OF EMBODIMENTS

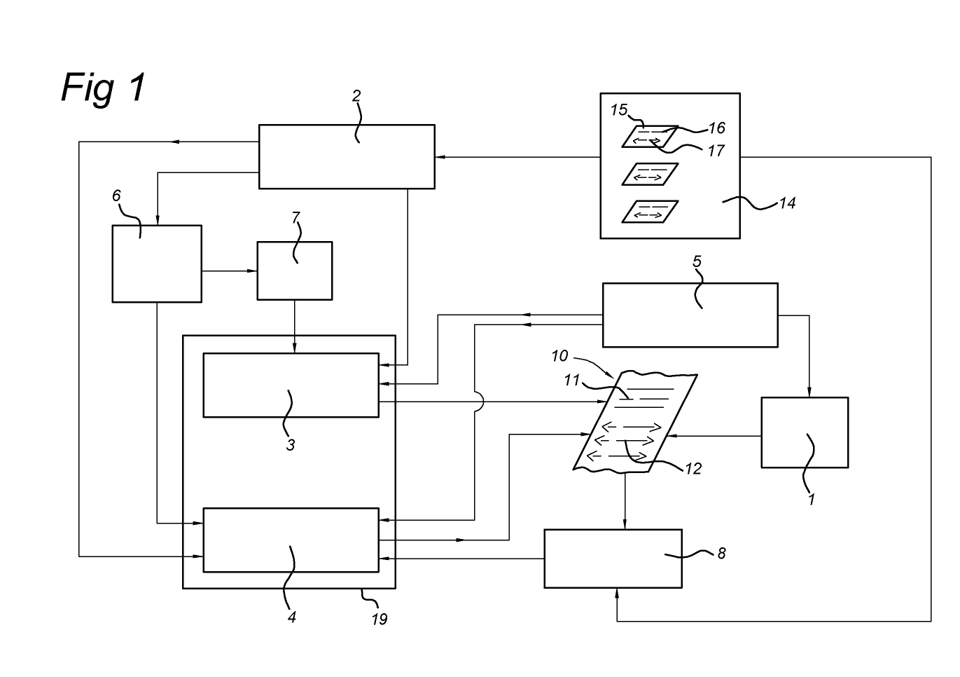

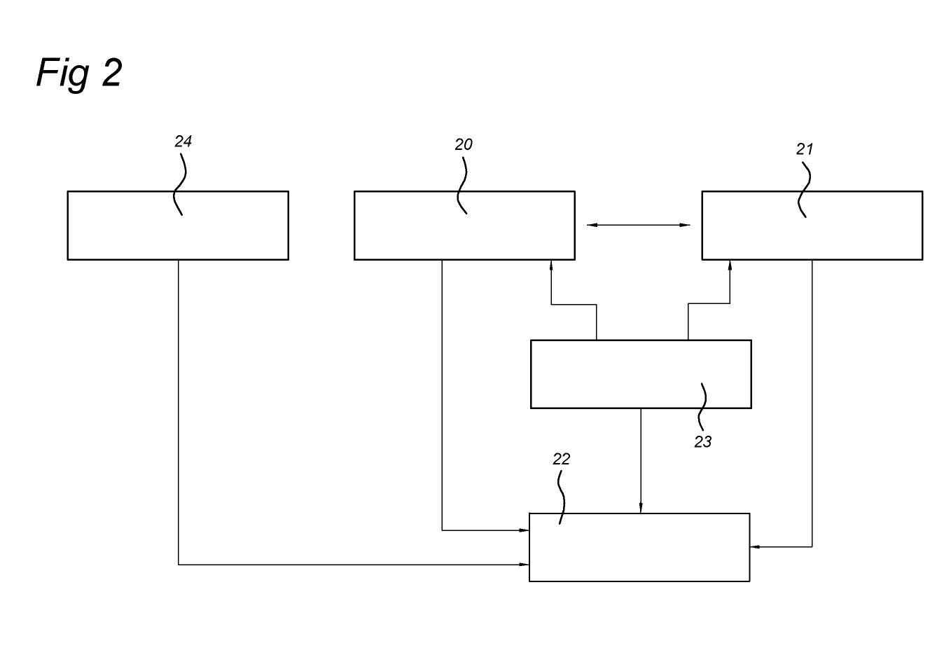

FIG. 1 illustrates an example of a document creation system. FIG. 2 illustrates an example of a macro editor. These systems may be implemented the same device, or on separate devices. A means may be provided to forward any generated macro from the macro editor to the document creation system. Alternatively, the macro may be provided to the document creation system in another form, for example build-in or delivered from another means. For example, the macro could be written manually in a macro language using a generic text editor. The document creation system and/or the macro editor may be implemented using dedicated electronic circuitry. Alternatively, these objects may be implemented at least partly by means of a computer program that may be loaded on a suitable computer device, such as a workstation or a dictation device. The document creation system and/or the macro editor may also be implemented within a handheld dictation device that comprises a speech recognition unit. In the drawings and the description, only those features are illustrated that may be necessary for an understanding of the techniques disclosed herein. The skilled person is capable of modifying or enhancing the illustrated embodiments using, for example, features from an existing document creation system and/or macro editor.

FIG. 1 illustrates an example of a document creation system. The system may comprise a text input unit 1 for receiving an input from a user for inclusion into a document 10 as text 11. The text input unit 1 may comprise, for example, a speech-to-text conversion unit (not shown), so that the text input unit is capable of recognizing dictated text. Alternatively or additionally, the system may comprise a text editing or word processing tool. Such tools are known in the art per se. The system may also be incorporated in a clinical decision support system or healthcare information system.

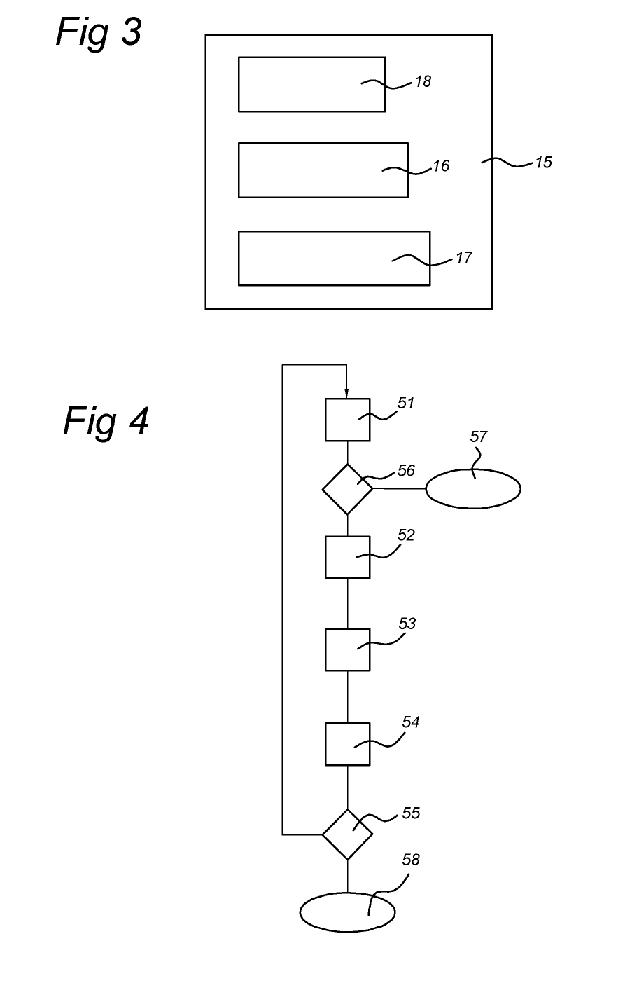

The system may comprise a selection input unit 2 for receiving a user selection of a macro 15. To this end, the system may comprise a macro storage area 14 in which one or more macros 15 are stored. Alternatively or additionally, a connection with a macro editor may be provided, enabling macros to be received by the system from the macro editor. The macro 15 may comprise a text portion 16 and structured semantic information 17 relating to the text portion 16. The text portion 16 may comprise free text in a natural language. The structured semantic information 17 may be formatted in a structured data format to represent the structure of the semantic information. A suitable example of a data format is XML. The text portion 16 and the structured semantic information 17 may be stored as separate data entities within the macro, or may be stored together in one data structure that embeds both the natural language text and the structured semantic information. For example, both types of information are included in an XML document. Besides, FIG. 3 shows additional detail of a possible implementation of a macro. In FIG. 3, the macro 15 additionally has a macro label 18. This macro label 18 may be used to select the macro. For example, the labels of available macros are displayed and the user is enabled to select one by pointing at the corresponding label using a mouse or a touch screen. Alternatively, the user is enabled to type or speak the label while providing the input to the text input unit 1, in order to select the corresponding macro.

The system may comprise a macro inserter 19. Such macro inserter may be responsible for inserting the text portion 16 of a macro 15 into the document 10 and annotating the document 10 with an annotation 12 based on the structured semantic information 17. In the presently described embodiment, the macro inserter 19 comprises a text inserter 3 and an annotation unit 4 as two separately drawn modules. However, these units may also be combined in a single module.

The macro inserter 19 may comprise a text inserter 3 for inserting the text portion 16 of the selected macro 15 into the document 10, in response to the user selection. For example, when the user types or speaks the label of a macro while providing input to the text input unit 1, the text inserter 3 may be arranged for inserting an appropriate text portion 16 based on the selected macro 15. This text portion 16 may replace the label 18 in the document's text 11.

The macro inserter 19 may further comprise an annotation unit 4 for annotating the document 10 with an annotation 12 based on the structured semantic information 17 stored in the selected macro 15. For example, this annotation 12 may comprise a copy of the structured semantic information 17. Possibly, this copy may be converted into another format as appropriate. Possibly, the annotation 12 resulting from the structured semantic information 17 of the macro 15 may be linked to the position within the document 10 that contains the copied text portion 16 of the macro 15. Possibly, the structured semantic information 17 of the macro 15 is embedded into a larger structured semantic information data object that describes a larger portion of the text 11 of the document 10.

The text input unit 1 may be operative with a user interface that provides display of the document-in-progress on a display device. Such arrangement of a user interface is known to the person skilled in the art per se. The document creation system may comprise a user controllable insertion point unit 5 operatively coupled with the text inserter 3. The insertion point unit 5 may be arranged for displaying a cursor or pointer at a position in the text 11 of the document 10 on a display, to indicate where newly provided text is going to be inserted. This position may be referred to as an insertion point. The same insertion point may be operatively coupled to the text input unit, for insertion of dictated or typed text, and to the text inserter 3 that inserts the macro-based text portion 16. Alternatively, two separate insertion points may be provided for this purpose. In either case, the text inserter 3 may be arranged for inserting the text portion 16 of a selected macro 15 at the text inserter's designated insertion point.

The text portion 16 of a macro 15 may comprise at least one blank to be filled in. Such a blank may be denoted in the text portion 16 by means of a special symbol, for example a ‘#’ sign. Alternatively, an XML tag may be used to indicate a blank. Other ways of storing the data describing a blank within a text portion 16 of a macro 15 are known to the person skilled in the art per se. When a macro 15 comprising one or more blanks is selected via the selection input unit 2, the user may be enabled to fill in the blank or blanks. To this end, the system may comprise a field input unit 6 arranged for receiving from the user at least one value associated with said at least one blank. For example, a pop-up window may be displayed that contains a form to be filled in using user interface elements that are known in the art per se. Moreover, after the values have been received from the user, they may be used to prepare a completed text portion without blanks. This task may be performed by a fill-in unit 7. The fill-in unit 7 may be operatively coupled to the text inserter 3, so that the latter is arranged for inserting the completed text portion (with filled-in blanks) into the text 11 of the document 10.

The structured semantic information 17 of a macro 15 may comprise semantic information associated with the blank. For example, a type of information to be provided in the blank is represented in the semantic information. Such a kind of semantic information may optionally be used by the field input unit 6 to provide a hint to the user as to what information the user should provide to fill in a blank. Moreover, this semantic information may be used by the annotation unit 4 to provide appropriate semantic annotation 12 of the filled-in blanks in the document 10.

The text portion 16 may comprise more than one blank. In such a case, the structured semantic information 17 may comprise a semantic relationship between the two blanks. For example, the first blank may denote a specific position within an organ denoted by the second blank. More examples are given elsewhere in this document. This information may then be included in the annotation 12 of the document 10.

The structured semantic information 17 may comprise a relationship between the semantics of at least part of the predetermined text portion and said at least one blank. This information may then be included in the annotation 12 of the document 10.

The document creation system may further comprise a parsing unit 8 for parsing the text 11 of the document 10 to find an occurrence of the text portion 16 of the macro 15. To this end, the parsing unit 8 may employ string matching or template matching techniques. Other techniques may also be used. The parsing unit 8 thus analyzes the text 11 encompassed by a document 10, looking for text portions that could have been the output of the macro text inserter 3. This way, when the user decides to spell out the text of a macro completely, the system is still capable of correctly annotating the text. Namely, the annotation unit 4 may be arranged for annotating the occurrence of the text portion based on the structured semantic information 17 of the macro. The parsing unit 8 may also be enhanced to take into account any blanks in the text portion 16 of a macro 15. This may be implemented using a technique of regular expressions.

FIG. 2 illustrates some components of a macro editor. The macro editor is arranged for generating a macro 15. The macro editor may comprise a text unit 20 arranged for receiving input indicative of a text portion 16. The macro editor may also comprise a semantics unit 21 arranged for receiving structured semantic information 17 relating to the text portion 16. Moreover, the macro editor may comprise a label unit 24 arranged for receiving a label 18. This label 18 may be considered a name of the macro 15. The label 18 may be used to facilitate selection of a macro in the document creation system. For example, the text unit 20, the semantics unit 21, and the label unit 24 may be arranged for receiving their respective information from a user, for example by means of a user interface such as a graphical user interface.

The macro editor may further comprise a macro generating unit 22 arranged for including the text portion 16 and the structured semantic information 17 into a macro 15. The macro generation unit 22 may be further arranged for associating the label 18 with the macro, for example by including the label 18 into a data structure representing the macro. Other ways to select a macro without a label are also envisaged. For example, the user may select a macro by means of its complete displayed text portion or by means of a graphical symbol. The macro 15 may be used by the document creation system set forth herein.

The text unit 20 may be arranged for enabling the user to include a blank in the text portion 16. For example, a user interface element such as a button may be provided to allow the user to insert a blank. Alternatively, a user may be enabled to input a special character or a character sequence that represents a blank. The macro editor may comprise a blank unit 23 operatively coupled to the text unit 20, the semantics unit 21, and the macro storing unit 22, for associating structured semantic information with the individual blanks in the text portion in the macro, and causing the macro storing unit 22 to store such blanks and associated structured information.

The semantics unit 21 may be arranged for enabling the user to indicate structured semantic information 17 relating to the blank. For example, the user may attach semantic labels to words or phrases in the text portion, and/or define relationships between words or phrases in the text portion. This may be done with a semantic markup language, for example, or by means of a graphical user interface. Likewise, the semantics unit 21 may be arranged for enabling the user to indicate structured semantic information 17 relating to a semantic relationship between at least two blanks of the at least one blank.

FIG. 4 schematically illustrates aspects of a document creation method by means of a flowchart. The method starts with step 51 of receiving an input from a user for inclusion into a document 10 as text 11. However, during such input the user may select a macro. Accordingly, in step 56, it is determined whether a macro is selected. If a macro is selected in step 56, the method proceeds at step 52 of receiving the user selection of a macro 15, wherein the macro 15 comprises a text portion 16 and structured semantic information 17 relating to the text portion 16. In step 53, the text portion 16 is inserted into the document 10, in response to the user selection. In step 54, the document 10 is annotated with an annotation 12 based on the structured semantic information 17. More details of the above-mentioned steps can be found in the description of the document creation system. After step 54, the method determines whether more user input is desired. If so, the method continues at step 51. Otherwise, the method may terminate at step 58. If, at step 56, it is detected that no macro is selected and that no further text input is to be expected, the method may be terminated at step 57.

A method of generating a macro 15 may comprise the following steps. The method may comprise a step of receiving input indicative of a text portion 16. The method may further comprise a step of receiving structured semantic information 17 relating to the text portion 16. After receiving these inputs, the method may perform the step of including the text portion 16 and the structured semantic information 17 into a macro 15. The method may allow the user to make corrections or other modifications to the text portion 16 and/or the structured semantic information 17. Finally, the macro 15 may be used in a document creation method as described herein. Both the described methods and systems are suitable for being implemented at least in part by means of a suitably programmed computer. An example of an alternative implementation includes a dedicated electronic circuitry to implement part or all functionalities.

Macros, by themselves, are known from existing speech recognition software that is used by clinical professionals, such as radiologists. A macro may be considered a command, for example a speech command, by which a pre-defined text fragment may be instantly inserted into the dictated report. Macros can also be activated through user selections on a dedicated GUI. As an example of a speech-controlled macro, consider the situation in which a clinician inserts the sentence “Homogenously enhancing fibroglandular breast density noted in both breasts.”, by simply saying the words denoting the label of the macro, for example “macro homogeneous fibro”. Similarly, a macro can be programmed to insert “Abnormality seen in ______ of the ______ breast, measuring ______×______ cm in ______ view.” by dictating the label of the macro, “macro mammogram abnormality”. The “______” designate fields that can be filled in with specific values, so that the result could look like: “Abnormality seen in upper outer quadrant of the left breast, measuring 1×2 cm in MLO view.”. Note that, although the example is explained in the context of speech driven automatic systems, similar functionality may be implemented with keyboard input or another kind of text input device.

Note here that the text portion of a macro, for example “Abnormality seen in ______ of the ______ breast, measuring ______×______ cm in ______ view.”, also referred to a macro scheme, implicitly defines, by means of natural language, the semantic categories of the elements inserted in the fields and the semantic relations between those fields. For instance, whatever is filled in the first field, it should be a region specifying a location in the breast. Also, from the text portion, it may be deduced by a human observer that the values of the third and fourth fields represent the size of the abnormality in centimeters.

The techniques disclosed therein provide a novel way of generating structured reports without natural language processing of the reports. As such it does not drastically change the current way of authoring reports.

A system with one or both of the following features may be implemented:

A macro editing environment in which clinicians, IT personnel and/or vendor's consultants can semantically annotate macros and macro schemes with a semantic mark-up language, such as the extensible mark-up language, XML. The mark-up language may allow to designate the semantic categories of the filled values, as well as interrelating them, by means of adding a hierarchical structure to them. All this is possible in XML, so the following examples are given in XML.

A document creation system that returns a report dictated as free text including used macros for inter-personal communication and another report that is structured, whence machine interpretable.

As an example the previous two macro examples are elaborated here with structured semantic information.

A first example macro has text portion “Homogenously enhancing fibroglandular breast density noted in both breasts.” and structured semantic information as follows:

<finding v=″fibroglandular density″ ID=”adf3e342424221”>

<bodyloc v=″breast″>

<region v=″both″/>

</bodyloc>
<modifier v=″homogeneously enhancing″/>

</finding>

A second example macro has text portion “Abnormality seen in ______ of the ______ breast, measuring ______×______ cm in ______ view.” and structured semantic information as follows:

<finding v=″abnormality″ ID=”areaaffaret5432”>

<bodyloc v=″breast″>

<region v=#0/>
<laterality v=#1/>

</bodyloc>
<size>

<dimension unit=″cm″ v=#2>
<dimension unit=″cm″ v=#3>

</size>
<image>

<view v=#4/>

</image>

</finding>

In this example, the placeholders for blanks “______” in the macro scheme have been replaced by variables #0 . . . #4. Moreover, the semantic categories are designated by the names of the XML elements: finding, bodyloc (shorthand notation for body location), region, size, etc.; whereas the semantic inter-relations between the elements can be constructed from their hierarchical ordering in the XML hierarchy.

Once the clinician has finished authoring the report, the system yields the structured report, which may comprise the XML object with the variable symbols replaced by the information provided by the user. For instance, the filled-in XML object corresponding to the second example and to be included into a report could look as follows:

<finding v=“abnormality”>

<bodyloc v=“breast”>

<region v=“upper outer quadrant”/>
<laterality v=“left”/>

</bodyloc>
<size>

<dimension unit=“cm” v=“1”>
<dimension unit=“cm” v=“2”>

</size>
<image>

<view v=“MLO”/>

</image>

</finding>

An editing environment can be constructed, and an engine can be developed that constructs a structured report from an unstructured report, based on the semantically enriched macros.

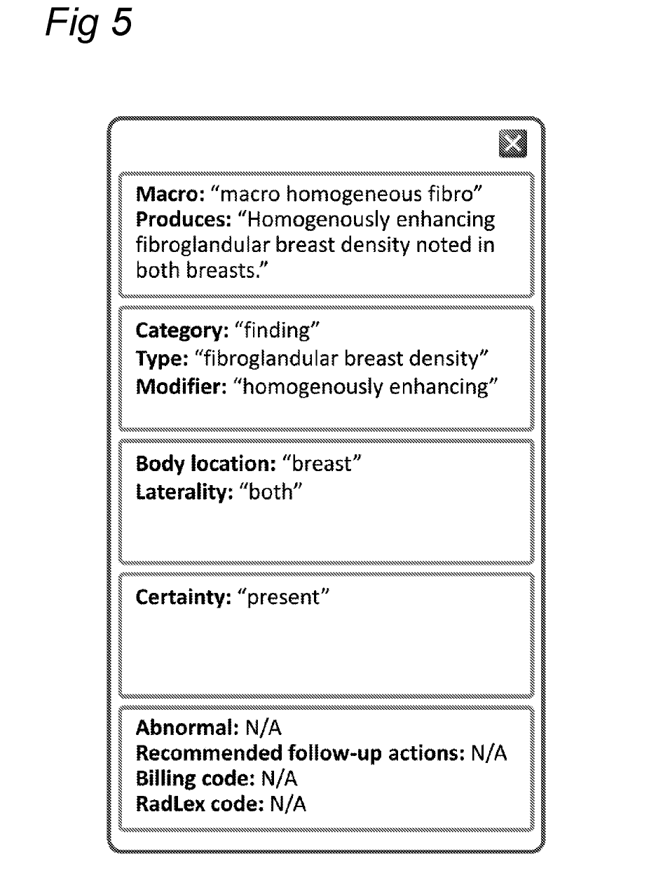

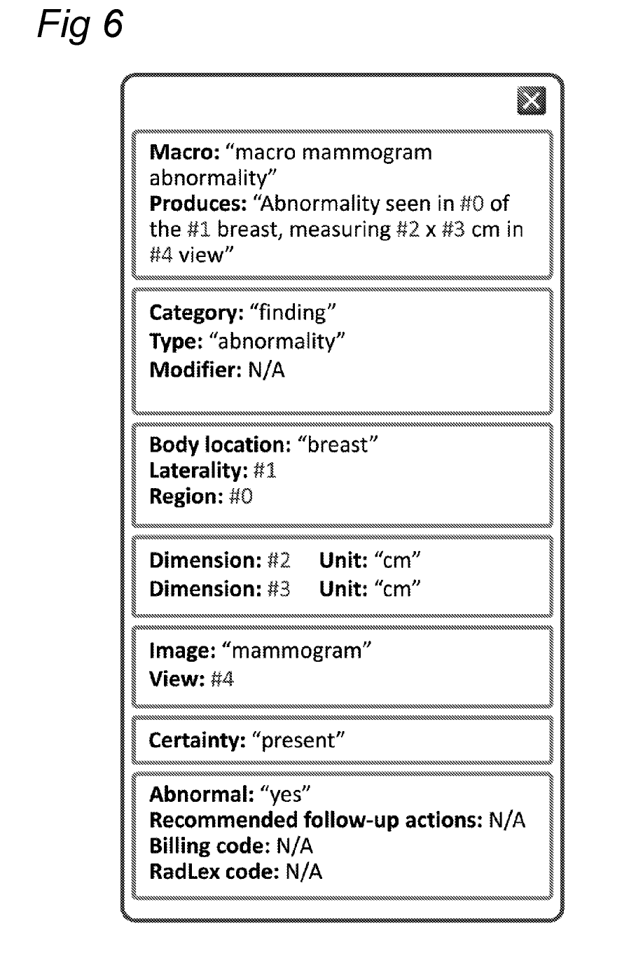

Editing environment. The editing environment can be integrated in the environment in which the macros are edited. Per macro the user is invited to construe an XML tree, albeit directly or by means of a drag-and-drop interface, in which graphical elements may be positioned as a tree. FIG. 5 and FIG. 6 show examples of graphical representations of a semantic macro that may be shown by the macro editor and/or the system for creating a document. In the macro editor, the user may interact with the visualization to change structured semantic information of a macro, such as “category”, type, modifier, body location, laterality etc., as well as the location and semantic information associated with blanks #0, #1, #2, etc. In the document creation system, such a visualization may provide text boxes enabling the user to provide values for the blanks, #0, #1, #2, etc. FIG. 5 corresponds to the first example macro above, and FIG. 6 corresponds to the second example macro above.

Pre-defined templates may be used that the user can copy and/or tailor to his needs. For instance, the user could be enabled to indicate that he/she wants to create a new macro of the finding category. The macro editor may retrieve from a template that a finding has a type and zero or more modifiers. In addition, the macro editor may find that a finding may have a body location, a certainty, and other properties. An example is illustrated in FIG. 5. Also support to the user can be given by means of drop down menus by which the user can simply select a body location from a predefined list of body locations.

If this predefined list is itself annotated, the suggestion process may continue for one or more levels deeper. For instance, if it is indicated in the template that body location “breasts” have laterality, we can automatically pop up a “Laterality” field in the editing environment, as illustrated by blank #1 in FIG. 6.

If an item is chosen from a predefined list, and the predefined list is itself annotated with concepts from one or more medical ontologies, these annotations can be transferred to the macro, so that the macro is standardized with respect to the underlying ontology. An advantage of standardized data is that it can be shared between users without loss of information or confusion. The user may be enabled to skip filling in some values. Also the user may choose to specify values that are not presented directly or indirectly in the sentence that is produced by the macro. For instance, the user could specify billing codes, which should not be present in the narrative report sent to the referring clinician, but that can be utilized for administration purposes.

Macro schemes can be constructed in a similar way. The user can use the variables to designate their semantic category and position in the produced sentence, see FIG. 6. The filled templates graphically shown in FIG. 5 and FIG. 6, which may also be displayed on a graphical user interface, can be converted automatically to the type of XML objects that were described above, for storage and retrieval purposes.

Structured report generation. It is possible to distinguish two ways to generate a structured report. The first comprises an integrative approach. As the user is dictating, using his macros and macro schemes, the reporting environment keeps tracks of the macros used and the values inserted in the fields of the macro schemes. This tracking system may account for the fact that some users may want to alter the contents generated by macros. If this happens the semantics of the macro cannot be guaranteed to be equivalent to the XML content generated, and thus the tracking mechanism may be arranged to remove such structured semantic information from the annotation (or structured content) of the report. In the integrative approach, when the clinician is finished dictating, no more processing needs to be done: the structured report is simply the collection of XML objects generated by the macros, module XML objects whose produced sentences were altered. Optionally, any text that was not inserted by means of macros may be left unannotated, or may be subjected to miscellaneous annotation mechanisms such as natural language processing.

A second approach accepts the narrative input from the dictation system and compares it against the macros. It may be arranged for splitting the contents of the narrative report in sentences, and consecutively checking if any of the sentences (or series of sentences) could have been produced at least partly by one of the macros. This can be done by regular expression matching. For each macro we can define a regular expression in which the variables are replaced by an expression that matches one or more words.

When a macro matches at least part of a sentence (or series of sentences), the regular expression may be used to extract the values filled in the blank fields of the macro, and insert them into appropriate slots in the macro's structured semantic information, which may take the form of an XML object. For instance when applying the second example macro, the following mapping would be constructed based on the sentence “Abnormality seen in upper outer quadrant of the left breast, measuring 1×2 cm in MLO view.”:

| | | |
|---|---|---|
| #0 | → | “upper outer quadrant” |
| #1 | → | “left” |
| #2 | → | “1” |
| #3 | → | “2” |
| #4 | → | “MLO” |

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A document creation system, comprising
a text input unit for receiving an input from a user for inclusion into a document as text;
a selection input unit for receiving a user selection of a macro, wherein the macro comprises a text portion and structured semantic information relating to the text portion;
a macro inserter for, in response to the user selection, inserting the text portion into the document and annotating the document with an annotation based on the structured semantic information.

2. The document creation system of claim 1, comprising a user controllable insertion point unit operatively coupled with the macro inserter for enabling a user to indicate a position within the document where the text portion is to be inserted.

3. The system according to claim 1,
wherein the text portion of a macro comprises at least one blank to be filled in;
wherein the system further comprises:
a field input unit for receiving from the user at least one value associated with said at least one blank; and
a fill-in unit for generating a completed text portion by filling in the blanks based on the at least one value;
and wherein the macro inserter is arranged for inserting the completed text portion into the document.

4. The document creation system of claim 3, wherein the structured semantic information of a macro comprises semantic information associated with the blank.

5. The document creation system of claim 4, wherein the structured semantic information comprises a type of information provided in the blank.

6. The document creation system of claim 3, wherein the text portion comprises at least two blanks, and wherein the structured semantic information comprises a relationship between the two blanks.

7. The document creation system of claim 3, wherein the structured semantic information further comprises a relationship between the semantics of at least part of the predetermined text portion and said at least one blank.

8. The document creation system of claim 1,
further comprising a parsing unit for parsing the text of the document to find an occurrence of the text portion of the macro; and
wherein the macro insertion unit is arranged for annotating the occurrence based on the structured semantic information of the macro.

9. A macro editor for generating a macro, comprising
a text unit for receiving input indicative of a text portion;
a semantics unit for receiving structured semantic information relating to the text portion;
a macro unit for including the text portion and the structured semantic information into a macro for use in a document creation system according to claim 1.

10. The macro editor according to claim 9, wherein the text unit is arranged for enabling the user to include a blank in the text portion.

11. The macro editor of claim 10, wherein the semantics unit is arranged for enabling the user to indicate structured semantic information relating to the blank.

12. A workstation comprising the system according to claim 1.

13. A document creation method, comprising
receiving an input from a user for inclusion into a document as text;
receiving a user selection of a macro, wherein the macro comprises a text portion and structured semantic information relating to the text portion;
in response to the user selection, inserting the text portion into the document and annotating the document with an annotation based on the structured semantic information.

14. A method of generating a macro, comprising
receiving input indicative of a text portion;
receiving structured semantic information relating to the text portion; and
including the text portion and the structured semantic information into a macro for use in a document creation system according to claim 1.

15. A computer program product comprising instructions for causing a processor system to perform the method according to claim 13.
